(19) United States
(12) Patent Application Publication
(10) Pub. No.: US 2017/0161612 A1
(43) Pub. Date: Jun. 8, 2017

(54) Partial Reinitialization for Optimizers

(71) Applicant: Microsoft Technology Licensing, LLC, Redmond, WA (US)

(72) Inventors: Matthew B. Hastings, Santa Barbara, CA (US); Nathan Wiebe, Redmond, WA (US); Ilia Zintchenk, Zurich (CH); Matthias Troyer, Zurich (CH)

(21) Appl. No.: 14/961,605

(22) Filed: Dec. 7, 2015

(51) Int. Cl. G06N 5/02; G06N 99/00

(52) U.S. Cl. CPC G06N 5/022; G06N 99/005

(57) ABSTRACT

In some examples, techniques and architectures for solving combinatorial optimization or statistical sampling problems use a recursive hierarchical approach that involves reinitializing various subsets of a set of variables. The entire set of variables may correspond to a first level of a hierarchy. In individual steps of the recursive process of solving an optimization problem, the set of variables may be partitioned into subsets corresponding to higher-order levels of the hierarchy, such as a second level, a third level, and so on. Variables of individual subsets may be randomly initialized. Based on the objective function, a combinatorial optimization operation may be performed on the individual subsets to modify variables of the individual subsets. Reinitializing subsets of variables instead of reinitializing the entire set of variables may allow for preservation of information gained in previous combinatorial optimization operations.

### BACKGROUND

Existing approaches to optimization depend on the type of systems or processes involved, including engineering system design, optical system design, economics, power systems, circuit board design, transportation systems, scheduling systems, resource allocation, personnel planning, structural design, and control systems. Goals of optimization procedures typically include obtaining the “best” or “near-best” results possible, in some defined sense, subject to imposed restrictions or constraints. Thus, optimizing a system or a process generally involves developing a model of the system or process and analyzing performance changes that result from adjustments in the model.

Depending on the application, the complexity of such a model can range from very simple to extremely complex. An example of a simple model is one that can be represented by a single algebraic function of one variable. On the other hand, complex models often contain thousands of linear and nonlinear functions of many variables.

Sometimes optimization problems are described as energy minimization problems, in analogy to a physical system having an energy represented by a function called an energy function or an objective function. Often a feasible solution that minimizes (or maximizes, if that is the goal) an objective function is called an optimal solution. In a minimization problem, there may be several local minima and local maxima. Most algorithms for solving optimization problems are not capable of making a distinction between local optimal solutions (e.g., finding local extrema) and rigorous optimal solutions (e.g., finding the global extrema). Moreover, many algorithms take an exponentially large amount of time for optimization problems due to the phenomenon of trapping in local minima.

### SUMMARY

This disclosure describes techniques and architectures for solving combinatorial optimization or statistical sampling problems using a recursive hierarchical approach that involves reinitializing various subsets of a set of variables. A system or process may be defined by a set of variables distributed in an n-dimensional space according to values of the individual variables. For example, such variables may include sampled or collected data. The entire set of variables of an optimization problem may correspond to a first level of a hierarchy. An objective function associates the set of variables with one another. In individual steps of the recursive process of solving an optimization problem, for example, the set of variables may be partitioned into subsets corresponding to higher-order levels of the hierarchy, such as a second level, a third level, and so on. Variables of individual subsets may be randomly initialized. With a goal of finding solutions to the objective function, an optimization operation may be performed on the individual subsets to modify variables of the individual subsets. Reinitializing subsets of variables instead of reinitializing the entire set of variables may allow for preservation of information gained in previous combinatorial optimization operations, for example. This approach may lead to faster and more efficient machine learning processes (e.g., for applications involving clustering, neural nets, hidden Markov models, and ranking, just to name a few examples).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), quantum devices, such as quantum computers or quantum annealers, and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIG. 1 is a block diagram depicting an environment for solving combinatorial optimization or statistical sampling problems using a hierarchical approach, according to various examples.

FIG. 2 is a block diagram depicting a device for solving combinatorial optimization or statistical sampling problems using a hierarchical approach, according to various examples.

FIG. 3 is a schematic diagram of a process for solving combinatorial optimization or statistical sampling problems using a hierarchical approach with partial reinitialization, according to various examples.

FIG. 4 is a schematic diagram of a detailed process for solving an example combinatorial optimization problem using a hierarchical approach with partial reinitialization.

FIG. 5 illustrates a perspective view of subsets of variables that are interrelated by an objective function and are on a number of levels of a hierarchy, according to various examples.

FIG. 6 illustrates two subsets of variables defined within particular distances from a subset-center, according to some examples.

FIG. 7 is a flow diagram illustrating a process for solving optimization problems, according to some examples.

FIG. 8 is a flow diagram illustrating a process for solving optimization problems, according to some examples.

### DETAILED DESCRIPTION

In many applications, a system or process to be optimized may be formulated as a mathematical model that is analyzed while solving an optimization problem. For example, such an optimization problem involves maximizing or minimizing a real function by systematically choosing input values from within an allowed set and computing the value of the function. Thus, an initial step in optimization may be to obtain a mathematical description of the process or the system to be optimized. A mathematical model of the process or system is then formed based, at least in part, on this description.

In various examples, a computer system is configured with techniques and architectures as described herein for solving a combinatorial optimization or statistical sampling problem. Such a problem, for example, may be defined by an energy function and described as a minimization problem for finding the minimum energy of the energy function. The energy function associates a set of variables that further define the combinatorial optimization or statistical sampling problem with one another.

Though techniques and architectures described herein are applicable to, but not limited to, combinatorial optimization problems, continuous optimization problems, and statistical sampling problems, the discussion focuses on combinatorial optimization problems, hereinafter “optimization problems”, for sake of clarity. Claimed subject matter is not so limited.

In some examples, heuristic optimizers that search for optimal configurations of variables relative to an objective function may become stuck in local optima where the search is unable to find further improvement. Some methods for escaping such local optima may involve adding noise and periodically restarting the search when no further improvement can be found. Although restarting may allow the search to get out of a local optimum, different restarts may be decoupled from one another. That is, information that was learned about the structure of the problem in one restart may not be passed on to the next restart so that the information has to be relearned from scratch.

Examples herein describe a method of “partial reinitialization” where, in an attempt to find improved optimal configurations (e.g., the solution), subsets of variables are reinitialized in a recursive fashion rather than the whole configuration of variables. This recursive structure to the resetting allows information gained from previous searches to be retained, which can accelerate convergence to the global optima in cases where the local optima found in prior searches yields information about the global optima. This method may lead to improvements in quality of the solution found in a given time for a variety of optimization problems in machine learning, for example.

A processor of a computer system uses a recursive hierarchical process for solving optimization problems by partitioning the set of variables into subsets on multiple levels of a hierarchy. For example, a first level may comprise the entire set of variables of the optimization problem, which the processor may partition into several second level subsets, each being a subset of the set of variables of the first level. The processor may partition each of the second level subsets into third level subsets and each of the third level subsets into fourth level subsets, and so on.

Recursive steps of the process include reinitializing, for example, a subset of the variables while maintaining values of (e.g., not reinitializing) the remaining variables. Such reinitializing may include setting individual variables of the subset to a random value. In some implementations, however, such reinitializing (or initializing) need not be random, and claimed subject matter is not limited in this respect. Based on the energy function, a processor may perform an optimization operation on the subset and the remaining variables of the set, the optimization operation modifying the variables and generating a modified subset. In some implementations, such a processor may be a quantum device, such as a quantum computer or quantum annealer. As described herein, performing the optimization operation on a subset may involve executing (e.g., “calling”) a function “SOLVE”, which comprises one or more operations that operate on the variables (e.g., one or more subsets and/or the entire set of variables). In some examples, SOLVE comprises executable instructions on computer-readable media that, when executed by one or more processors, configure the one or more processors to perform the one or more operations that operate on the variables. For instance, the optimization operation may be a simulated annealing operation.

After performing the optimization operation, if the optimization operation yielded a better objective function, then the processor retains and uses the modified variables for a subsequent application of the optimization operation. On the other hand, if the optimization operation yielded a worse value of the objective function than was observed for the previous values of the variables, then the processor may revert the variables to their previous values. The processor may then use the resulting variables (subset and non-subset variables) for a subsequent application of the optimization operation.

In some examples, the processor may determine whether to reinitialize the subset or to retain and later use the modified variables based, at least in part, on a probability function. Such a probability function, as discussed in detail below, may depend on a number of parameters, such as the level of the hierarchy in which the subset resides, the number of optimization operations performed, and so on.

After performing a number of optimization operations that yield a modified subset having sufficiently poor value of the objective function, the process may repeat in a “restart” process using another subset of the variables. For example, such a restart process may involve randomly reinitializing individual variables of a new subset. The restart process repeats the optimization operations on the new subset having the reinitialized variables. Subsequent restart processes tend to yield subsets that increasingly optimize the value of the objective function.

In some examples, the processor passes results of applying optimization operations on the subsets of a particular level of the hierarchy to subsets of the next higher level. For instance, performing the optimization operation on variables of second level subsets may be based on results of applying the optimization operation on variables of first level subsets.

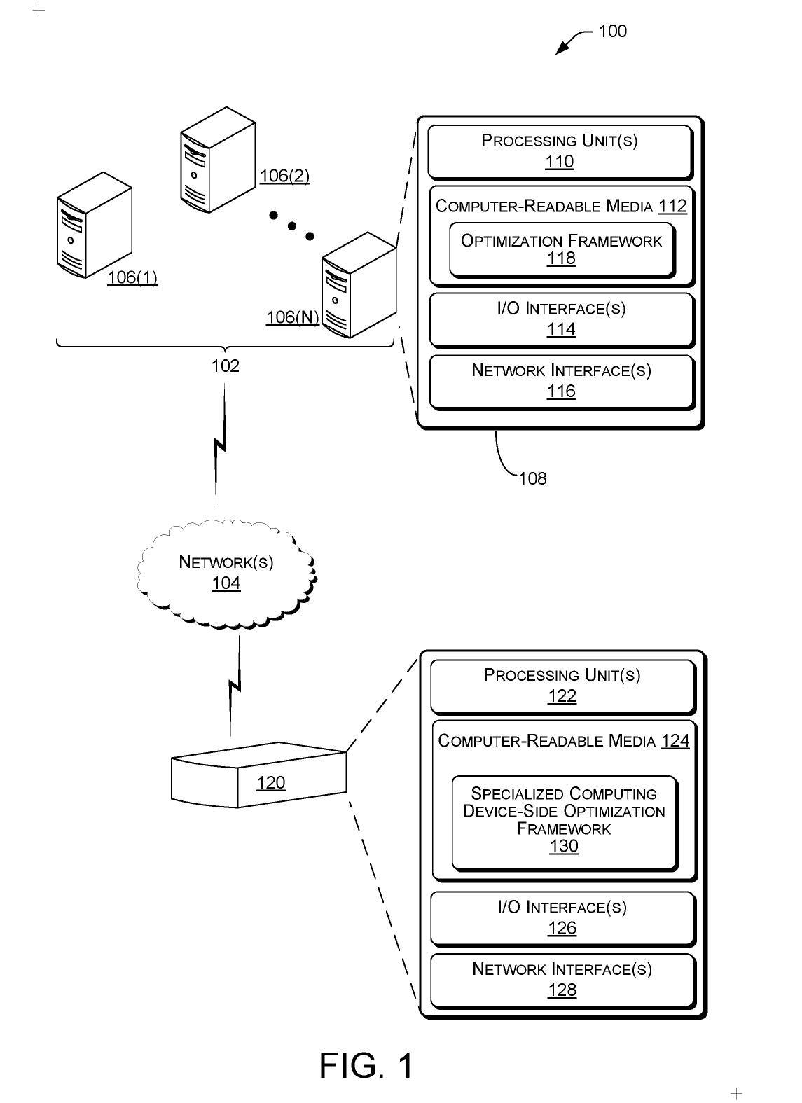

Various examples are described further with reference to FIGS. 1-8.

FIG. 1 is a block diagram depicting an environment 100 for solving optimization problems using a recursive hierarchical approach, according to various examples. In some examples, the various devices and/or components of environment 100 include distributed computing resources 102 that may communicate with one another and with external devices via one or more networks 104.

For example, network(s) 104 may include public networks such as the Internet, private networks such as an institutional and/or personal intranet, or some combination of private and public networks. Network(s) 104 may also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 104 may utilize communications protocols, including packet-based and/or datagram-based protocols such as internet protocol (IP), transmission control protocol (TCP), user datagram protocol (UDP), or other types of protocols. Moreover, network(s) 104 may also include a number of devices that facilitate network communications and/or form a hardware basis for the networks, such as switches, routers, gateways, access points, firewalls, base stations, repeaters, backbone devices, and the like.

In some examples, network(s) 104 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 1302.11 standards (e.g., 1302.11g, 1302.11n, and so forth), and other standards.

In various examples, distributed computing resource(s) 102 includes computing devices such as devices 106(1)-106(N). Examples support scenarios where device(s) 106 may include one or more computing devices that operate in a cluster or other grouped configuration to share resources, balance load, increase performance, provide fail-over support or redundancy, or for other purposes. Although illustrated as desktop computers, device(s) 106 may include a diverse variety of device types and are not limited to any particular type of device. Device(s) 106 may include specialized computing device(s) 108.

For example, device(s) 106 may include any type of computing device having one or more processing unit(s) 110 operably connected to computer-readable media 112, I/O interfaces(s) 114, and network interface(s) 116. Computer-readable media 112 may have an optimization framework 118 stored thereon. For example, optimization framework 118 may comprise computer-readable code that, when executed by processing unit(s) 110, perform an optimization operation on subsets of a set of variables for a system. Also, a specialized computing device(s) 120, which may communicate with device(s) 106 via networks(s) 104, may include any type of computing device having one or more processing unit(s) 122 operably connected to computer-readable media 124, I/O interface(s) 126, and network interface(s) 128. Computer-readable media 124 may have a specialized computing device-side optimization framework 130 stored thereon. For example, similar to or the same as optimization framework 118, optimization framework 130 may comprise computer-readable code that, when executed by processing unit(s) 122, perform an optimization operation.

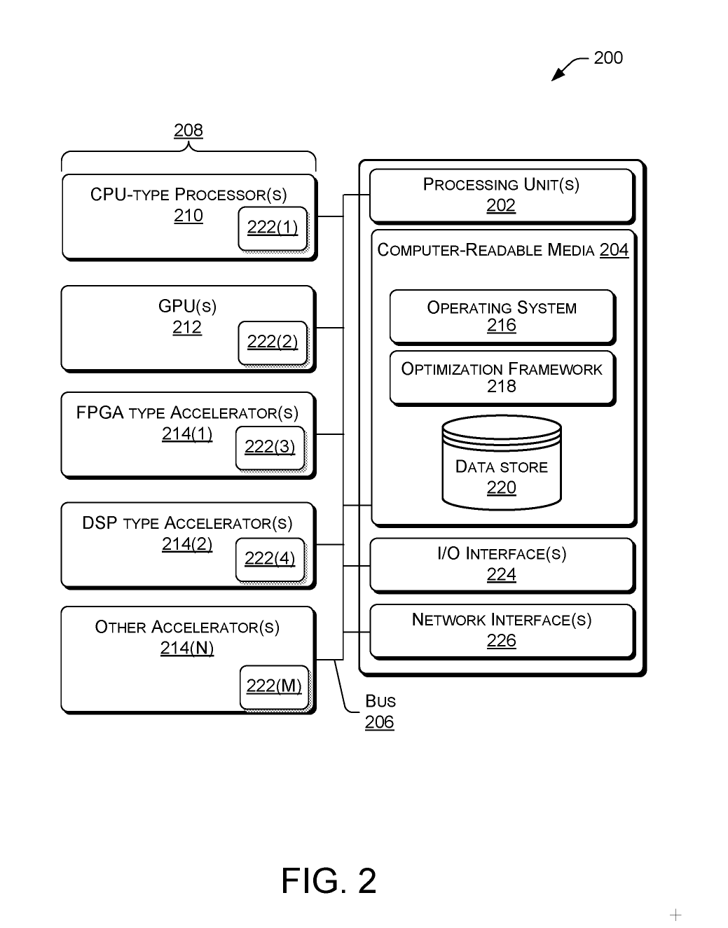

FIG. 2 depicts an illustrative device 200, which may represent device(s) 106 or 108, for example. Illustrative device 200 may include any type of computing device having one or more processing unit(s) 202, such as processing unit(s) 110 or 122, operably connected to computer-readable media 204, such as computer-readable media 112 or 124. The connection may be via a bus 206, which in some instances may include one or more of a system bus, a data bus, an address bus, a PCI bus, a Mini-PCI bus, and any variety of local, peripheral, and/or independent buses, or via another operable connection. Processing unit(s) 202 may represent, for example, a CPU incorporated in device 200. The processing unit(s) 202 may similarly be operably connected to computer-readable media 204.

The computer-readable media 204 may include, at least, two types of computer-readable media, namely computer storage media and communication media. Computer storage media may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. The computer-readable media 112 and the computer-readable media 124 are examples of computer storage media. Computer storage media include, but are not limited to hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

In contrast, communication media may embody computer-readable instructions, data structures, program modules, or other data in a modulated data signal, such as a carrier wave, or other transmission mechanism. As defined herein, computer storage media does not include communication media.

Device 200 may include, but is not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device such as one or more separate processor device(s) 208, such as CPU-type processors (e.g., micro-processors) 210, GPUs 212, or accelerator device(s) 214.

In some examples, as shown regarding device 200, computer-readable media 204 may store instructions executable by the processing unit(s) 202, which may represent a CPU incorporated in device 200. Computer-readable media 204 may also store instructions executable by an external CPU-type processor 210, executable by a GPU 212, and/or executable by an accelerator 214, such as an FPGA type accelerator 214(1), a DSP type accelerator 214(2), or any internal or external accelerator 214(N).

Executable instructions stored on computer-readable media 202 may include, for example, an operating system 216, an optimization framework 218, and other modules, programs, or applications that may be loadable and executable by processing units(s) 202, and/or 210. For example, optimization framework 218 may comprise computer-readable code that, when executed by processing unit(s) 202, perform an optimization operation on subsets of a set of variables for a system. Alternatively, or in addition, the functionally described herein may be performed by one or more hardware logic components such as accelerators 214. For example, and without limitation, illustrative types of hardware logic components that may be used include Field-programmable Gate Arrays (FPGAs), Application-specific Integrated Circuits (ASICs), Application-specific Standard Products (ASSPs), quantum devices, such as quantum computers or quantum annealers, System-on-a-chip systems (SOCs), Complex Programmable Logic Devices (CPLDs), etc. For example, accelerator 214(N) may represent a hybrid device, such as one that includes a CPU core embedded in an FPGA fabric.

In some examples, optimization framework 218 may comprise a hierarchical structuring module configured to partition a set of variables into a hierarchy of levels. In some examples, optimization framework 218 may comprise a solving module to perform a number of functions described herein. In some examples, optimization framework 218 may comprise a memory module configured to access any portion of computer-readable media 204 and operable by operating system 216. The memory module may store a set of initialized or non-initialized variables and an objective function that associates the set of the variables with one another, for example.

In the illustrated example, computer-readable media 204 also includes a data store 220. In some examples, data store 220 includes data storage such as a database, data warehouse, or other type of structured or unstructured data storage. In some examples, data store 220 includes a relational database with one or more tables, indices, stored procedures, and so forth to enable data access. Data store 220 may store data for the operations of processes, applications, components, and/or modules stored in computer-readable media 204 and/or executed by processor(s) 202 and/or 210, and/or accelerator(s) 214. For example, data store 220 may store version data, iteration data, clock data, optimization parameters, and other state data stored and accessible by the optimization framework 218. Alternately, some or all of the above-referenced data may be stored on separate memories 222 such as a memory 222(1) on board CPU type processor 210 (e.g., microprocessor(s)), memory 222(2) on board GPU 212, memory 222(3) on board FPGA type accelerator 214(1), memory 222(4) on board DSP type accelerator 214(2), and/or memory 222(M) on board another accelerator 214(N).

Device 200 may further include one or more input/output (I/O) interface(s) 224, such as I/O interface(s) 114 or 126, to allow device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). Device 200 may also include one or more network interface(s) 226, such as network interface(s) 116 or 128, to enable communications between computing device 200 and other networked devices such as other device 120 over network(s) 104. Such network interface(s) 226 may include one or more network interface controllers (NICs) or other types of transceiver devices to send and receive communications over a network.

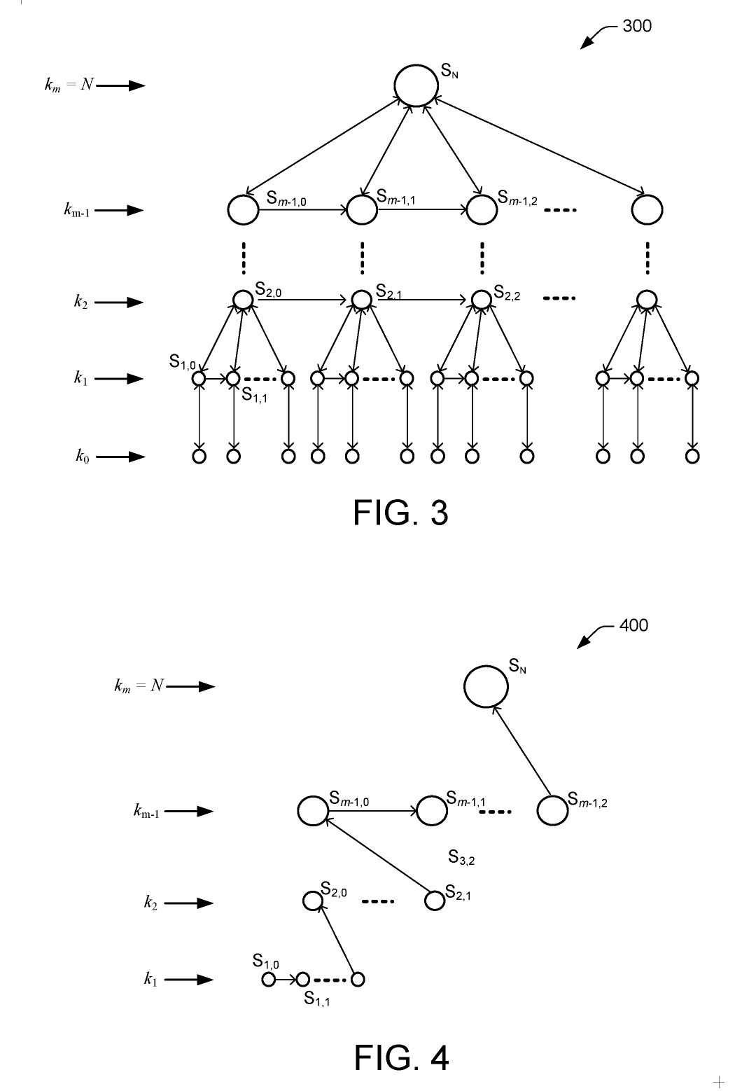

FIG. 3 is a schematic diagram of a process 300 for solving optimization or statistical sampling problems using a hierarchical approach with partial reinitialization, according to various examples. Such an approach may involve any number of hierarchical levels, which are labelled kₘ, where m=1, 2, 3 . . . N. On each level kₘ, subsets of variables, represented by circles, may be reinitialized. There are many ways that the number of variables in each hierarchical level can be chosen. In some implementations, the number of variables may be chosen to form an increasing sequence. Specifically, the number of variables in level k is greater than the number of variables in subsets in level k₋₁, which is greater than the number of variables in subsets in level k₂, which is greater than the number of variables in subsets in level k₁. In other words, the size of subsets is less for levels furthest from the top level (kₘ=1V).

In the example illustrated, the top level kₘ=N includes the entire set of variables S_{N} of the optimization problem. The next level down in the hierarchy, kₘ₋₁, includes subsets S_{m-1,0}, S_{m-1,1}, S_{m-1,2}, and so on. In some examples, the combination of S_{m-1,0}, S_{m-1,1}, S_{m-1,2} . . . need not encompass the entire set S_{N}. In other words, S_{N} may include variables that are not included in any of S_{m-1,0}, S_{m-1,1}, S_{m-1,2} . . . . The next level down in the hierarchy, k₂, includes subsets S_{2,0}, S_{2,1}, S_{2,2}, and so on. In some examples, the combination of S_{2,0}, S_{2,1}, S_{2,2} . . . need not encompass the entire set S_{N}. In other words, S_{N} may include variables that are not included in any of S_{2,0}, S_{2,1}, S_{2,2} . . . . The next level down in the hierarchy, k₁, includes subsets S_{1,0}, S_{1,1}, S_{1,2}, and so on. In some examples, the combination of S_{1,0}, S_{1,1}, S₁₂ . . . need not encompass the entire set S_{N}. In other words, S_{N} may include variables that are not included in any of S_{1,0}, S_{1,1}, S_{1,2} . . . . The lowest level of the hierarchy represents the fundamental optimizer that is being improved using partial reinitialization.

In some examples, a processor may perform a heuristic that selects among a set of variables to form subsets of the variables. An objective function may associate the set of variables with one another. For example, a set of variables may comprise a few variables up to hundreds of variables or more. Subsets may comprise some fractions thereof. Herein, k-optimality of an optimizer is defined such that for any configuration the optimizer returns, reinitializing the variables in a typical subset smaller than k found by this heuristic does not get the configuration out of a local optimum. That is, the optimizer would just return the same configuration again. However, reinitializing subsets of k₁>k variables may allow the optimizer to find a set of new local optima, some of which may be worse or better than the current local optimum. Starting from level m=0, the processor may proceed to higher levels (e.g., m=1, m=2, and so on) of the hierarchy until a better local optimum is reachable for a subset picked by the heuristic. A local optimum may be considered to be good if the probability of finding a better local optimum is negligible using the current optimization strategy. If a current local optimum is good, then proceeding to higher levels of the hierarchy may reduce likelihood of finding a better local optimum. Hence, except in the very beginning of an optimization process, the optimizer may have a greater chance of finding a better local optimum after reinitializing subsets of exclusively m levels rather than reinitializing N variables, where for example k₁<k₂ and so forth.

A k-optimum configuration is one where an optimizer will fail to find a better value of an objective function based on reinitializations of at most k variables in an initial configuration. This is distinct from an optimal configuration because the optimizer may fail to reach the global optimum from any configuration that differs from the initial configuration using at most k points. Also, for the discrete case on N variables, an N-optimum configuration is the global optimum because it provides the best solution over all possible reinitializations of the variables.

In an example of a process starting with level m=1, as subsets are reinitialized and the optimizer called after each reinitialization, the configuration may become k₁-optimal with high likelihood. The likelihood of finding a better local optimum correspondingly decreases. To prevent the optimizer from becoming stuck in the k₁-optimum, subsets of level 2, which have size k₂ that is greater than k₁, may be reinitialized. In turn, to get out of a k₂-optimum, subsets of level 3, which have a greater size than those of level k₂, may be reinitialized. Such a process may repeat for additional levels. Repeating this process iteratively, each time increasing the size of the subsets until kₘ=N, the configuration becomes N-optimal, which may be the global optimum with high probability. This process can thus refine a local optimizer into a global optimizer. In some examples, the processor may use the following pseudo-code.

```
Input: current level l, number of reinitializations Mₗ, and number of
variables for each reinitialization kₗ.
if l = 0 then
  call heuristic optimizer on x
else
  x₀ ← x
  reinitialize subset of kₗ variables in x.
  for i ε {1... Mₗ} do
    call partial reinitialization on level l - 1
  end for
  if cost(x) > cost(x₀) then
    x ← x₀
  end if
end if
```

With m levels in the hierarchy, the process may be started from the mth level. The global configuration is denoted by x and the checkpoints by x₀ At each level l, Mₗ reinitializations of kₗ variables may be performed. The number of variables in subsets in level m (kₘ=N) is greater than the number of variables in subsets in level m−1 (kₘ₋₁). Such a condition is similarly true for lower levels of the hierarchy. Thus, the number of variables in subsets in level m−1 is greater than the number of variables in subsets in level l.

The processor may select the number of variables in subsets and may select which of the variables are in particular subsets in particular levels of the hierarchy, for example. In some examples, the processor may select variables at random. However, if variables are selected according to a problem-specific heuristic, the likelihood that reinitializing a subset of a given size leads to a more optimal configuration may be increased. For example, the processor may select subsets such that the optimality of variables within the subset depends on the values of the other variables in the subset as much as possible. In other words, the processor may select variables for a subset so that the variables within the subset are coupled to one another in some fashion. In such a case, the likelihood of escaping a local optimum may increase by reducing the number of constraints on the subset from the rest of the system.

The optimization process proceeds in this example by first initializing all variables. This process is also called “a global reinitialization”. Then an optimization procedure is used to find a local optima at level 0. This configuration and value of the objective function is then taken to be the “check point”. The variables that comprise the set S_{1,0} are then reinitialized and the optimizer is applied again. If the value of the objective function is improved by this optimization then the checkpoint is set to the current configuration and the iteration continues. Otherwise, the current configuration is set to the value at the checkpoint and the optimization process is repeated ignoring the sub-optimal configuration found at the current attempt. This process is repeated until it is likely that no reinitialization of size |S_{1,k}| will meaningfully change the objective function. Then this entire optimization process, including the reinitialization procedure, is considered to be an optimizer that is queried in a similar fashion after reinitializing variables in the set S_{2,1} This process is then repeated until it is unlikely that any reinitialization of sub-sets of variables of size S_{2,k} will substantially affect the value of the objective function. This process is then continued recursively for a total of m levels, in each case the fundamental optimizer is taken to be the basic optimizer augmented with several layers of partial reinitialization as described above.

Global reinitializations may be independent from one other and can thus run in parallel. Partial reinitializations may be connected by checkpoints and may not be parallelized. However, a hybrid approach may involve performing multiple runs within a level in parallel, and the most optimal configuration found in all of the runs may be collected.

In some examples, the outcome of a heuristic optimizer may not directly depend on an initial configuration of a set of variables, but rather merely on a random seed. In such cases, the optimizer may be used to optimize exclusively the variables within a subset while the other variables of the set may be kept fixed. Such an approach may be employed for finding ground states of Ising spin glasses with simulated annealing, for example.

If an optimization problem is over the space of continuous variables (as opposed to discrete variables), the concept of partial reinitialization may be extended to partially reinitializing each variable in addition to subsets of variables. That is, rather than setting a variable to a random value within a pre-defined domain, the variable's current value may be perturbed by, for example, adding noise with some standard deviation. Thus, a processor may perform techniques that fully reinitialize subsets of the variables, add small perturbations to all the variables, or combine the two techniques to partially perturb subsets of the variables. Accordingly, in addition to the number of variables in each subset kₗ and the number of subsets Mₗ, a parameter εₗ describes the perturbation strength at each level of the hierarchy, and which may be used to further improve performance.

In some examples, a processor may perform full reinitialization (as opposed to partial reinitialization) of each variable in a problem with continuous variables. On the other hand, there are a number of ways that partial reinitialization may be implemented in the continuous setting. For example, the processor may perturb each subset (e.g., vector) by replacing the components of the subset with a weighted mixture of their original values and a Gaussian distribution. In some examples, the processor may use the following pseudo-code.

```
Input: vector xₖ, mixing factor α, variance σ², mean μ
for each x ε xₖ do
  x ← α x + (1-α) N(μ, σ²).
  reinitialize variable by adding Gaussian noise.
end for
```

FIG. 4 is a schematic diagram of a detailed process 400 for solving an example combinatorial optimization problem using a hierarchical approach with partial reinitialization. Process 400 comprises an example portion of process 300. In particular, process 400 begins at the level l wherein kₗ variables are reinitialized. In some implementations, the processor may perform an optimization process subsequent to initializing all variables to random values. In other implementations, the processor may perform the optimization process subsequent to receiving (e.g., and need not initialize) variables, which may have random or selected values. The optimization process may generate new values for the variables. Subsequently, the processor may partially reinitialize subset S_{1,0} of the variables. That is, subset S_{1,0} may be partially reinitialized, possibly to random values, while values for the remaining variables of the optimization problem will be unchanged during the reinitialization process. Next, the processor may perform an optimization process using the partially reinitialized variables. The optimization process may generate new values for the variables. Again, the processor may partially reinitialize subset S_{1,0} of the variables. That is, subset S_{1,0} may be partially reinitialized, possibly to random values, while values for the remaining variables of the optimization problem will be unchanged during the reinitialization process. This procedure (e.g., optimization, partial reinitialization, optimization . . . ) may repeat until the processor determines that a subsequent iteration will not substantially improve the solution to the optimization problem. In other words, the processor may infer the occurrence of diminishing returns, which indicates that subsequent iterations are converging to a local optimum.

In some examples, the processor may perform such an inference by comparing a latest result of the optimization process with a previous result of the optimization process to determine an amount by which the latest result is closer than the previous result to a local optimum. If the amount is less than a threshold value, then process 400 may advance to a subsequent subset (S_{1,1}) for reinitialization in order to escape from the local optimum. If the amount is greater than the threshold value, then process may re-use the current subset (S_{1,0}) for reinitialization. In the former case, to escape the local optimum, the new subset S_{1,1} of the variables of the optimization problem may be reinitialized. That is, the variables of the subset S_{1,1} may be partially reinitialized, possibly to random values, while values for the remaining variables (including the variables of the “former” subset S_{1,0}) of the optimization problem will be unchanged during the reinitialization process.

Accordingly, the processor may perform an optimization process subsequent to the reinitialization. The optimization process may generate new values for the variables. Subsequently, the processor may partially reinitialize subset S_{1,1} of the variables. That is, subset S_{1,1} may be partially reinitialized, possibly to random values, while values for the remaining variables of the optimization problem will be unchanged during the reinitialization process. Next, the processor may perform an optimization process using the partially reinitialized variables. The optimization process may generate new values for the variables. Again, the processor may partially reinitialize subset S_{1,1} of the variables. This procedure (e.g., optimization, partial reinitialization, optimization . . . ) may repeat until the processor determines that a subsequent iteration will not substantially improve the solution to the optimization problem. In this situation, to escape the local optimum, a new subset S_{1,2} of the variables of the optimization problem may be reinitialized.

The procedure described above is performed on the first level of the hierarchy. In some examples, after working through all the subsets of the first level (e.g., S_{1,0}, S_{1,1}, S_{1,2} . . . ) the procedure advances to the next higher level, which is the second (m=2) level. In other examples, the procedure may advance to the next higher level after working through a portion of all the subsets of reachable at the first level. In some implementations, the procedure may advance to the next higher level after determining which subset (e.g., S_{1,0}, S_{1,1}, S_{1,2} . . . ) of the first level, via a number of reinitializations, resulted in the best solution. For example, a solution resulting from reinitializing subset S_{1,1} in an iterative optimization process may be better than a solution resulting from reinitializing all the other subsets on the first level. Thus, the procedure may advance to the second level using the resulting best solution found on the first level using the subset S_{1,1}.

On the second level, the processor may partially reinitialize subset S_{2,0} of the variables (which comprises k₂ variables). That is, subset S_{2,0} may be partially reinitialized, possibly to random values, while values for the remaining variables of the optimization problem will be unchanged during the reinitialization process. Next, the processor may perform an optimization process using the partially reinitialized variables. The optimization process may generate new values for the variables. Again, the processor may partially reinitialize subset S_{2,0} of the variables. That is, subset S_{2,0} may be partially reinitialized, possibly to random values, while values for the remaining variables of the optimization problem will be unchanged during the reinitialization process. This procedure (e.g., optimization, partial reinitialization, optimization . . . ) may repeat until the processor determines that a subsequent iteration will not substantially improve the solution to the optimization problem. In other words, the processor may infer the occurrence of diminishing returns, which indicates that subsequent iterations are converging to a local optimum.

In this case, to escape the local optimum, the new subset S_{2,1} of the variables of the optimization problem may be reinitialized. That is, the variables of the subset S_{2,1} may be partially reinitialized, possibly to random values, while values for the remaining variables (including the variables of the “former” subset S_{2,0}) of the optimization problem will be unchanged during the reinitialization process.

Accordingly, the processor may perform an optimization process subsequent to the reinitialization. The optimization process may generate new values for the variables. Subsequently, the processor may partially reinitialize subset S_{2,1} of the variables. Next, the processor may perform an optimization process using the partially reinitialized variables. The optimization process may generate new values for the variables. Again, the processor may partially reinitialize subset S_{2,1} of the variables. This procedure (e.g., optimization, partial reinitialization, optimization . . . ) may repeat until the processor determines that a subsequent iteration will not substantially improve the solution to the optimization problem. In this situation, to escape the local optimum, a new subset S_{2,2} of the variables of the optimization problem may be reinitialized.

The procedure described above is performed on the second level of the hierarchy. In some examples, after working through the subsets of the second level the procedure advances to the next higher level. In this fashion, process 400 advances to level m, such that kₘ=N, where a solution to the optimization problem comprises particular values of all the variables resulting from iterative optimization of reinitialized subsets of the lower levels.

In various examples, process 300 and 400 may operate in a system that includes subsets of variables on a hierarchy of levels in relation to an objective function defined for the system. For instance, a processor may use such subsets for a process of minimizing (or maximizing) an objective function over a set of states {s} for the system. The processor may use such a process for solving an optimization problem for the system defined by the objective function.

In some examples, the objective function of the system may be a function of a set of variables that are related to one another by equation [1].

E({s})=Σ_{i,j}(J_{i,j}sᵢsⱼ)+Σᵢ(sᵢhᵢ [1]

Σ_{i,j} represents a matrix of real numbers indexed over i and j, hᵢ are real numbers, and sᵢ and sⱼ are variables of the set {s}. In some implementations, such variables may comprise a set of real numbers. The first term, which includes J_{i,j}, is a coupling term that defines coupling among the set of variables. In a particular implementation, the set {s} comprises spin states, having values +1 or −1. E({s}) for a system may be called the “energy” of the system. (The terms “spin states” and “energy” arise from an analogy between optimization and metallurgy.) There are N different sᵢ labeled by i=1 . . . N. E({s}) is a function of the set of all s, s₁ . . . s_{N}. Solving an optimization problem involving E({s}) includes finding the set of variables {s} that yield a maximum or a minimum value for E({s}), though claimed subject matter is not limited in this respect. For the case of the set of variables {s} comprising the set of spins, the optimization problem for E({s}) is carried out over sᵢ=+1 and −1.

Herein, for sake of clarity, discussions of various examples focus on minimization (as opposed to maximization) of the objective function. Generally, an objective function includes a plurality of local minima and one global minimum. For example, a particular E({s}) may include a number of minima. Solutions to the optimization problem for the system defined by the objective function may yield local minima, falling short of finding the global minimum. For at least this reason, techniques for solving optimization problems may be recursive, continuing to seek improvements to the last solution(s) found. For example, a process for solving the optimization problem may yield a first solution that is a local minimum, and it would not be known whether it is a local minimum or the global minimum. Thus, the process may continue to search for a better solution, such as a better local minimum or the global minimum.

A processor may solve an optimization problem defined by the objective function using a recursive hierarchical approach that partitions variables {s} for particular states of the system into subsets on multiple levels of a hierarchy. For example, a first subset comprises a first portion of the variables {s}, a second subset comprises a second portion of the variables {s}, and so on. Moreover, the processor may partition each of such subsets into sub-subsets corresponding to lower levels of the hierarchy. As defined herein, sub-subsets (e.g., “second-order subsets”) of subsets (e.g., “first-order subsets”) are in a lower level as compared to the subsets. For example, if a first-order subset is in a fourth level, then the second-order subsets are in the third level.

A process of solving the optimization problem defined by the objective function may depend on a parameter L, which is the total number of levels of the hierarchy that will be considered during the solving process. As discussed above, each such level includes one or more subsets. Any of a number of methods may be used to define the subsets. For example, in one method, for a particular nth-order level, a subset comprises a set of variables (e.g., spins) within a distance dₙ from some central value (e.g., central spin), where dₙ decreases with increasing n. A choice of dₙ may depend on the particular optimization problem. The distance dₙ may be defined using a graph metric, for example. In other methods, subsets may be defined so that the subsets include variables that are coupled to one another in some particular way. Such coupling may exist for variables within a distance dₙ from one another. In some implementations, distance dₙ may decrease geometrically with increasing n. For example, such coupling among variables may be defined by J_{i,j} in equation [1].

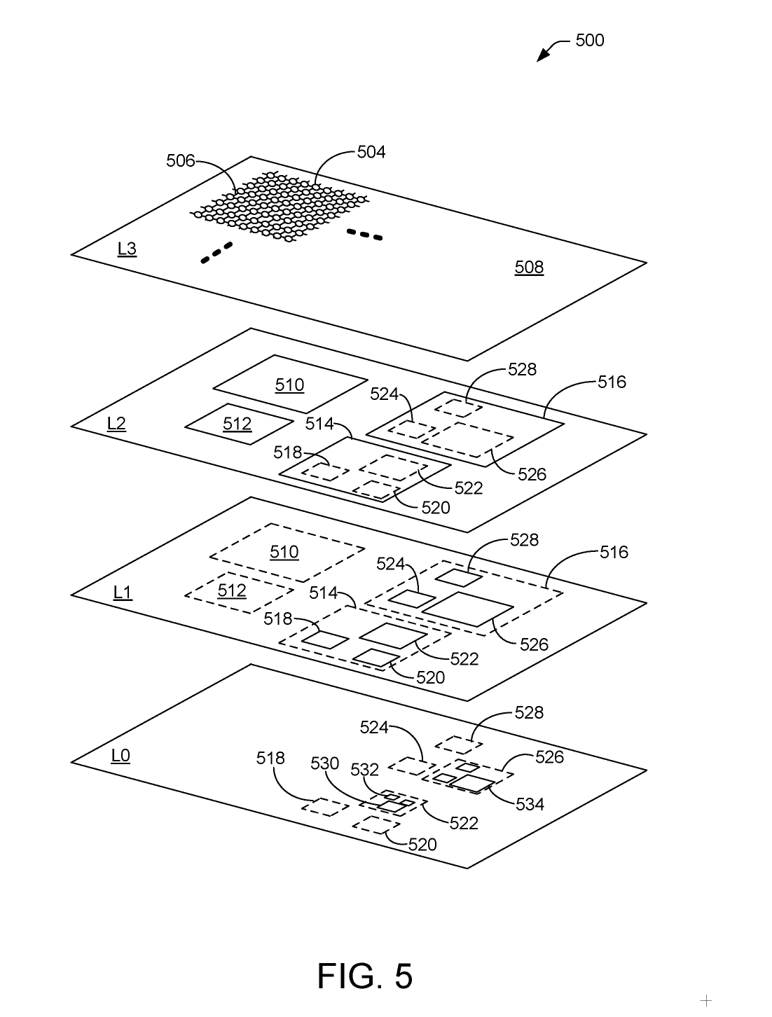

FIG. 5 illustrates a perspective view of subsets of variables that are interrelated by an objective function and are on a number of levels of a hierarchy 500, according to various examples. Hierarchy 500 includes four levels, L0-L3, though any number of levels is possible, and claimed subject matter is not limited in this respect. For instance, as described for processes 300 and 400, a processor may use subsets in the various levels for a process of minimizing (or maximizing) an objective function over a set of states {s} for the system. Such a process may be used for solving an optimization problem for the system defined by the objective function.

In the perspective view in FIG. 5, the objective function for a particular set of states {s} may comprise a topographical surface (in any number of dimensions corresponding to the number of variables) having a plurality of extrema. In some examples, the objective function of the system may be a function of a set of variables {s} that are related to one another by an equation such as equation [1], described above. A number of variables 504 in level L3 are illustrated as small circles interconnected by lines 506, which represent the possibility that any of the variables may be coupled to one or more other variables, though such coupling need not exist for all the variables. In some implementations, such variables may comprise a set of real numbers. In a particular implementation, the set {s} comprises spin states, having values +1 or −1.

Similar to examples described in relation to FIG. 3, a processor may solve an optimization problem defined by the objective function using a hierarchical approach that partitions variables {s} for particular states of the system into subsets. For example, a first subset comprises a first subset of the variables {s}, a second subset comprises a second subset of the variables {s}, and so on. Moreover, the processor may further partition each of such subsets into higher-order subsets corresponding to the hierarchical levels. As defined herein, higher-order subsets are in a lower level as compared to lower-order subsets. For example, if second-order subsets are in level L2, then first-order subsets are in a level L3 and third-order subsets are in level L1.

In the particular example illustrated in FIG. 5, level L3 includes one subset 508, which includes all of the variables in L3. Subset 508 may be partitioned into subsets 510, 512, 514, and 516. Thus, level L2 includes four subsets 510, 512, 514, and 516, which are sub-subsets of subset 508. As explained above, the processor may partition individual subsets into sub-subsets, which in turn may be partitioned into higher-order subsets, and so on. Thus, continuing with the description of FIG. 5, the processor may partition each of subsets 510, 512, 514, and 516 into sub-subsets so that, for example, subset 514 includes sub-subsets 518, 520, and 522. Subset 516 includes sub-subsets 524, 526, and 528. Subsets 510, 512, 514, and 516 are illustrated with dashed outlines on level L1 and solid outlines in level L2.

For the next lower level, which is level L0, the processor may partition each of subsets 518, 520, 522, 524, 526, and 528 (which are sub-subsets of subsets 514 and 516, respectively) into sub-subsets so that, for example, subset 522 includes sub-subsets 530 and 532. Subset 526 includes sub-subsets 534. For sake of clarity, not all sub-subsets are labeled. Subsets 518, 520, 522, 524, 526, and 528 are illustrated with dashed outlines in level L0 and solid outlines in level L1.

The hierarchical process of iteratively defining sub-subsets on lower levels may continue beyond level L0. Though particular numbers of levels and sub-subsets are illustrated, claimed subject matter is not so limited. Moreover, solving an optimization problem may involve any number of levels, subsets, and sub-subsets. For example, subset 514 in level L2 may include any number of sub-subsets in level L1, and so on. Though not illustrated for sake of clarity, subsets or sub-subsets may overlap one another. Thus, for example, subset 514 may overlap with subset 516.

In a particular example implementation, a hierarchical process may involve a process of simulated annealing for solving optimization problems for any of the subset (of subsets thereof) on levels L3-L0. For example, a processor may use simulated annealing on subsets of any level. For an illustrative case, variables sᵢ in the set {s} of the system may comprise spins having values of +1 or −1. In this case, in the process of simulated annealing the processor initializes the variables sᵢ of a sub-subset randomly to +1 or −1, choosing each one independently in a process of random initialization. An example of finding a solution for a system of spins in described below.

In some implementations, a parameter called the “temperature” T is chosen based on any of a number of details regarding the system. A processor may choose different values for T for different subsets and/or for different iterations of the hierarchical process. Subsequent to random initialization and reinitialization, the processor performs a sequence of “annealing steps” using the chosen value for T. In an annealing step, the processor modifies variables sᵢ to generate a new set {s′} for the sub-subset, where values of sᵢ may be flipped from +1 to −1 or vice-versa. The processor then determines whether the energy of new set {s′} is lower than the energy of the original set {s}. In other words, the processor determines whether the annealing step yielded a new energy E(s′) lower than the original energy E(s). If so, if E(s′)<E(s), the processor replaces (e.g., “accepts the update”) variables of the set {s} with variables of the set {s′}. On the other hand, if E(s′)>E(s), the processor conditionally replaces variables of the set {s} with variables of the set {s′} based on a probability that may depend on a difference between E(s′), E(s), and T. For example, such a probability may be expressed as exp[−(E(s′)−E(s))/T], where “exp” is the exponential operator that acts on the expression within the square brackets. The processor performs a sequence of annealing steps at a given T, then reduces T, again performs annealing, and continues in this iterative fashion. The sequence of T and the number of annealing steps for each T is termed the “schedule”. At the end of the process, T may be reduced to zero, and the last configuration of variables of a new set {s″} is a candidate for the minimum. The processor performs several restarts of the process, starting again with a randomly initialized configuration of individual subsets and again reducing T following a schedule and the best choice of {s} at the end of the process may be the best candidate for the minimum.

The choice of the schedule for T may be specified by a particular sequence of T and a particular sequence of the number of steps performed at each temperature. The schedule may also specify the number of restarts. A simulated annealing process may be performed in parallel at different values for T, for example.

In an example system described by a set of spins, the processor may find the global ground state for the system by a process of recursively optimizing subsets of spins. The processor may start with a random global state and sequentially pick M subsets having N_{g} spins in each subset.

A new spin configuration G obtained by optimizing a subset of spins may either replace the previous configuration, or in case of heuristic solvers, replace the previous configuration if the configuration energy is lowered. Alternatively, such replacement may be based on a probabilistic criterion. For a subset size where N_{g}=1, the process may be the same as or similar to simulated annealing.

In some examples, subsets are defined so that spins within a subset are strongly coupled to one another and weakly coupled to the system outside of the subset. Such a subset may be built by starting from a single spin and adding spins until the subset has reached a desired size. Spins that are most strongly coupled to the subset and weakly to the rest of the system may be added first. Thus, spins neighboring those already in the subset may be considered. In other examples, single spins may be added probabilistically. In still other examples, instead of single spins, sets of spins may be added to a subset.

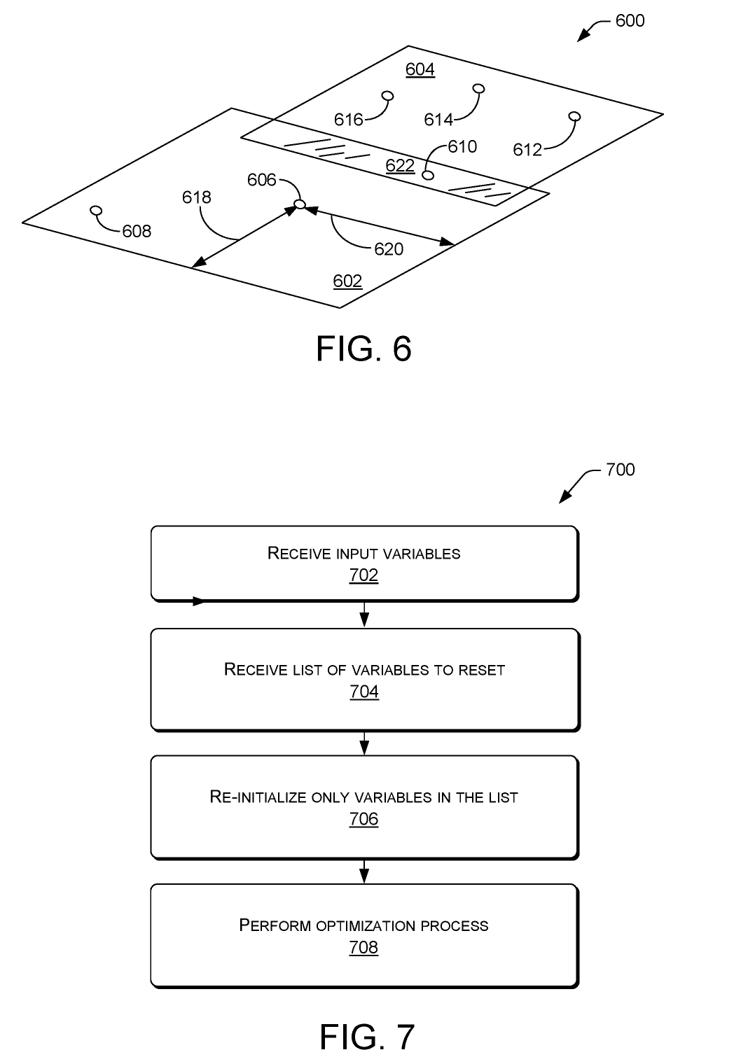

FIG. 6 illustrates two subsets 602 and 604 of variables defined within particular distances from a subset-center, according to some examples. A processor may use such subsets in an optimization problem defined by an objective function E({s}) for a system that associates variables sᵢ of a set {s}. Subsets 602 and 602 may be in a particular level of a hierarchy of levels. Subsets 602 and 604 result from partitioning variables {s} for particular states of the system. For example, subset 602 comprises a first subset of the variables {s}, a few of which are shown. In particular, subset 602 includes variables 606, 608, and 610. For the discussion below, variable 606 is considered to be a “subset-center” variable. Subset 604 comprises a second subset of the variables {s}, a few of which are shown. In particular, subset 604 includes variables 610, 612, 614, and 616. Though not illustrated in FIG. 6, additional subsets may exist and such subsets may be partitioned into sub-subsets that comprise subsets of the set {s}.

Though illustrated as being square-shaped and two-dimensional, subsets 602 and 604 may have any shape and have any number of dimensions. Subsets may be defined in any of a number of ways. For example, subset 602 may be defined to include a subset of variables that are within a distance 618 of subset-center variable 606 in a first direction and are within a distance 620 of central variable 606 in a second direction. In other examples, not shown, a circular or spherical subset may be defined to include a subset of variables that are within a radial distance of a central variable. A choice of such distances may depend on the particular optimization problem. Distance may be defined using a graph metric, for example.

Subsets may overlap one another. For example, subset 602 and subset 604 overlap so that both include a subset of variables in a region 622. One such variable is 610, which is a variable of both subset 602 and subset 604.

Variables of the set {s} may be coupled to one another in various ways. In some implementations, a matrix of real numbers, such as J_{i,j} in equation [1], may define the coupling among the variables. For example, coupling among the variables may be based on distances between respective variables. In some implementations, such distances may decrease geometrically with decreasing level. The strength of such coupling may also vary among pairs of variables within a particular level. For example, coupling between variables 614 and 616 may be weaker than coupling between variables 614 and 610. A subset may be defined so that the subset includes variables that are more strongly coupled to each other, relative to variables outside the subset.

FIG. 7 is a flow diagram illustrating a process 700 for solving an optimization problem, according to some examples. Process 700, which may be performed by a processor such as processing unit(s) 110, 122, and 202, for example, involves defining a number of subsets hierarchically in a number of levels. In particular, a processor partitions subsets in a level into sub-subsets in a next lower level, and the sub-subsets are themselves partitioned in sub-subsets in still a next lower level, and so on. Accordingly, sub-subsets in lower levels are generally smaller than corresponding subsets (or sub-subsets) in higher levels. For at least this reason, optimization operations performed on subsets in lower levels tend to more easily find solutions as compared to subsets in higher levels.

At block 702, the processor may receive a number of input variables of the optimization problem. In particular, the variables may be associated with one another by an function (e.g., equation 1) that defines the optimization problem. At block 702, the processor may receive a list of variables that are a subset of the input variables. The subset of variables, called “subset”, is designated to be the variables among the input variables that are reinitialized. At block 706, the processor may partially reinitialize the subset, possibly to random values, while values for the remaining input variables will be unchanged during the reinitialization process. At block 708, the processor may perform an optimization process using the partially reinitialized variables. The optimization process may generate new values for the variables.

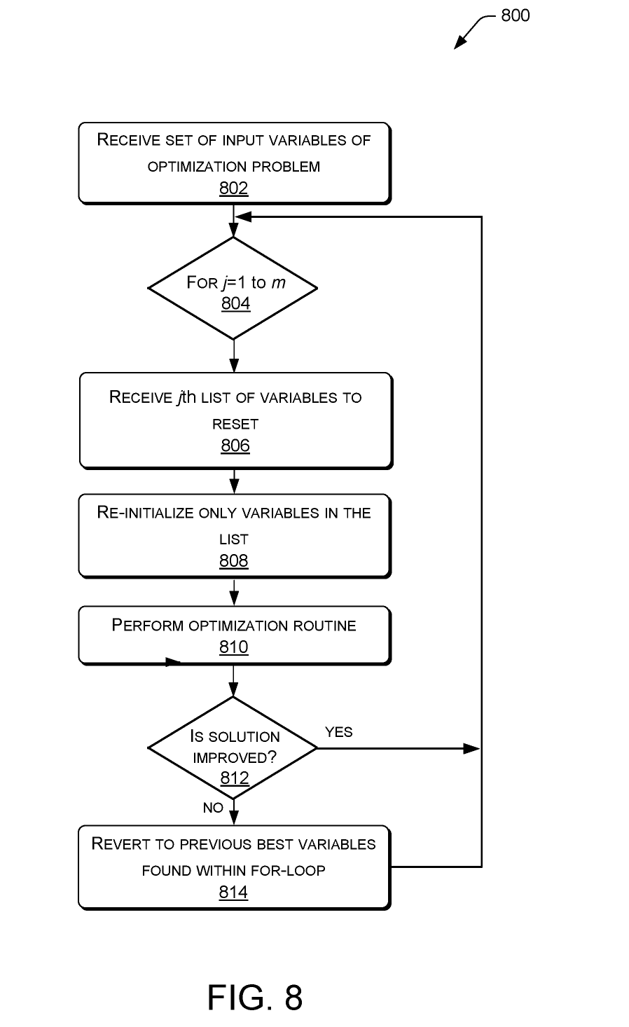

FIG. 8 is a flow diagram illustrating a process 800 for iteratively solving an optimization problem, according to some examples. Process 800, which may be performed by a processor such as processing unit(s) 110, 122, and 202, for example, involves defining a number of subsets hierarchically in a number of levels. Process starts at block 802, where the processor may receive a set of input variables of the optimization problem. In particular, the variables may be associated with one another by an energy function (e.g., equation 1) that defines the optimization problem. At diamond 804, process 800 begins an iterative for-loop “m” number of times. m may be selected based, at least in part, on a desired speed for finding a solution to the optimization problem and the desired quality of the solution. At block 806, the processor may receive a list of variables that are a subset of the input variables. The subset of variables, called “subset”, is designated to be the variables among the input variables (or the portion thereof) that are reinitialized. In particular, each iteration of the for-loop may have a different subset. Thus, at block 806, the jth subset includes the variables to be reinitialized for the jth iteration of the for-loop.

At block 808, the processor may partially reinitialize the jth subset, possibly to random values, while values for the remaining set of input variables will be unchanged during the reinitialization process. At block 810, the processor may perform an optimization process using the partially reinitialized variables and the remaining non-initialized variables. The optimization process may generate new values for all the variables.

At diamond 812, the processor may determine whether the resulting solution is improved compared to a previous solution (e.g., the solution found in the previous for-loop iteration). For example, the processor may determine that a subsequent iteration will not substantially improve the solution to the optimization problem. In other words, the processor may infer the occurrence of diminishing returns, which indicates that subsequent iterations are converging to a local optimum. The processor may perform such an inference by comparing the solution of the optimization process of the current for-loop iteration (jth) with the solution of the optimization process of the previous for-loop iteration (j−1).

If the solution is not substantially improved, process 800 may proceed to block 814, where the processor may revert back to the best solution found among all the for-loop iterations. If process 800 operates on a particular level of a hierarchy, for example, then the processor may move up to the next higher level and use the best solution to initialize the set of variables and to initialize a new subset, defined on the higher level.

If the solution is substantially improved, process 800 may return to diamond 804 to start a new for-loop iteration using another subset (e.g., the jth+1 subset). Process 800 then repeats block 806 through diamond 812 to iteratively perform optimization, partial reinitialization, optimization, and so on, while the condition at diamond 812 is satisfied.

The flows of operations illustrated in FIGS. 7 and 8 are illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor to perform the recited operations. In the context of hardware, the blocks may represent one or more circuits (e.g., FPGAs, application specific integrated circuits—ASICs, etc.) configured to execute the recited operations.

Any process descriptions, variables, or blocks in the flows of operations illustrated in FIGS. 7 and 8 may represent modules, segments, or portions of code that include one or more executable instructions for implementing specific logical functions or variables in the process.

In some examples, as described above, a processor may use a hierarchical process based on recursively optimizing groups (e.g., subsets) of variables of a system to heuristically find the ground state of spin glasses (e.g., variables being +1 or −1). A relatively simple heuristic process for finding the optimal solution of the system includes generating random spin configurations and recording the energy of the resulting configurations. Such examples involve discrete variables and discrete optimization problems. Processes and configurations described above may, however, apply to continuous optimization problems as well. For example, recursive, hierarchical processes that involve partial reinitialization may be applied to Boltzmann training. Boltzmann machines are a class of highly generalizable models, related to feed-forward neural networks that may be useful for modeling data sets in many areas including speech and vision. A goal in Boltzmann machine training is not to replicate the probability distribution of some set of training data but rather to identify patterns in the data set and generalize them to cases that have not yet been observed.

The Boltzmann machine may take a form defined by two layers of units. Visible units comprise the input and output of the Boltzmann machine and hidden units are latent variables that are marginalized over to generate correlations present in the data. The vector of visible units is v and the vector of hidden units is h. These units may be binary and the joint probability of a configuration of visible and hidden units is

P(v,h)=exp(−E(v,h))/Z, [2]

where Z is a normalization factor known as the partition function and

E(v,h)=−v·a−h·b−v^{T}Wh, [3]

where W is a matrix of weights that models the interaction between pairs of hidden and visible units and a and b are vectors of biases for each of the units. This model may also be viewed as an Ising model on a complete bipartite graph that is in thermal equilibrium.

This model is known as a Restricted Boltzmann Machine (RBM). Such RBMs may be stacked to form layered Boltzmann machines, which are sometimes called deep Boltzmann machines. For simplicity, descriptions below include training RBMs since training deep Boltzmann machines using popular methods, such as contrastive divergence training, generally involves optimizing the weights and biases for each layered RBM independently.

The training process involves optimizing the maximum likelihood training objective, O_{ML}, which is

O_{ML}=E_{d}(ln [EₕP(v,h)])−λΣᵢⱼW²ᵢⱼ/2 [4]

where λ is a regularization term introduced to prevent overfitting E_{d} is the expectation value over the training data provided and Eₕ is the expectation value over the hidden units of the model. The exact computation of the training objective function is #P hard, which means that its computation is expected to be intractable for large RBMs under reasonable complexity theoretic assumptions.

Although O_{ML} may not be efficiently computed, its derivatives may be efficiently estimated using a method known as contrastive divergence. The algorithm uses a Markov chain algorithm that estimates the expectation values of the hidden and visible units which are needed to compute the derivatives of O_{ML}. Specifically,

∂/∂Wᵢⱼ[O_{ML}]=<vᵢhⱼ>_{data}−<vᵢhⱼ>_{model}−λWᵢⱼ [5]

Here, “<- ->_{data}” denotes an expectation value over the Gibbs distribution of equation [2] with the visible units clamped to the training data and the “<- ->_{model}” denotes the unconstrained expectation value. The derivative with respect to the biases is similar. Locally optimal configurations of the weights and biases may then be calculated by stochastic gradient ascent using these approximate gradients.

Since this procedure yields configurations that are approximately locally optimal, the partial reinitialization method described previously may be used to accelerate the optimization process relative to simply restarting the algorithm from scratch with completely random initial weights and biases. This may be illustrated by examining small synthetic examples of Boltzmann machines where the training objective function can be calculated exactly.

Techniques and processes described herein may be applied to any of a number of machine learning problems, which may be studied to determine performance advantages of partial reinitialization (e.g., as described herein) compared to full reinitialization for finding optimum model parameters. In an example application of machine learning temporal patterns in a signal, only one additional level is described in the hierarchy between a full reinitialization and calling the heuristic optimizer. That is, for each full reinitialization, multiple reinitializations of subsets of variables may be performed. To maintain generality, subsets may be chosen at random in the example application. The parameters in the benchmarks, such as the size of each of the subsets (denoted by k₁) and the number of partial reinitializations (denoted by M₁) which are done within each full reinitialization, may be selected heuristically to be roughly optimal and need not be the true optima for the respective performance metrics.

Learning temporal patterns in a signal may be useful in a wide range of fields including speech recognition, finance and bioinformatics. A classic method to model such systems is hidden Markov models (HMM), which are based on the assumption that the signal follows a Markov process. That is, the future state of the system depends solely on the present state without any memory of the past. This assumption turns out to be substantially accurate for many applications.

In discrete HMMs, considered here, the system may be in one of N possible states hidden from the observer. Starting from a discrete probability distribution over these states, as time evolves the system can transition between states according to an N×N probability matrix A. Each hidden state may emit one of M possible visible states. The model is hence composed of three parts: the initial probability distribution of length N over the hidden states; the N×N transition matrix between hidden states; the N×M emission matrix from each hidden state into M possible visible states. During training on a given input sequence, these matrices may be optimized such as to maximize the likelihood for this sequence to be observed.

The standard algorithm for training HMMs is the Baum-Welch algorithm, which is based on the forward-backward procedure, which computes the posterior marginal distributions using a dynamic programming approach. The model is commonly initialized with random values and optimized to maximize the expectation of the input sequence until convergence to a local optimum. To improve accuracy, multiple restarts may be performed. Over a sequence of restarts, partial reinitialization, as described herein, may improve the convergence rate towards a global optimum as compared to full reinitialization.

Techniques and processes described herein may be applied to dividing objects into clusters according to a similarity metric may be important in data analysis and is employed ubiquitously in machine learning. Given a set of points in a finite-dimensional space, the idea is to assign points to clusters in such a way as to maximize the similarities within a cluster and minimize the similarities between clusters. One of the most widely used processes for finding such clusters is the k-means algorithm. The k-means algorithm searches for an assignment of points to clusters such as to minimize the within-cluster sum of square distances to the center. Starting from a random assignment of points, each iteration proceeds in two stages. First, all points may be assigned to the nearest cluster center. In the second part, each center may be picked to be the Euclidean center of its cluster. This is repeated until convergence to a local optimum. Similar to the Baum-Welch algorithm, multiple restarts may be performed to improve the quality of the clusters. Techniques and processes involving partial reinitialization, as described herein, may provide significantly better and faster solutions as compared to full reinitialization.

Similar advantages involving partial reinitialization may be realized with clustering with k-medoids, where clustering data involves selecting the best cluster center to be one of the points in the cluster rather than the Euclidean center.

### Example Clauses

A. A system comprising: one or more processing units; and computer-readable media with modules thereon, the modules comprising: a memory module to store a set of variables and an objective function that associates the set of variables with one another; a hierarchical structuring module to partition the set of variables into a first-level subset and a second-level subset, wherein the first-level subset is a subset of the second-level subset, and the second-level subset is a subset of the set of variables; and a solving module to: reinitialize the first-level subset prior to performing first-level optimization operations on the objective function that are based, at least in part, on the reinitialized first-level subset; reinitialize the second-level subset prior to performing second-level optimization operations on the objective function that are based, at least in part, on the reinitialized second-level subset; and determine a local optimum configuration for the objective function based, at least in part, on the second-level optimization operations.

B. The system as paragraph A recites, wherein a size of the first-level subset is less than a size of the second-level subset.

C. The system as paragraph A recites, wherein the solving module is configured to: maintain values of the set of variables while reinitializing the first-level subset or while reinitializing the second-level subset.

D. The system as paragraph A recites, wherein the solving module is configured to: determine a rate of convergence toward a k-optimum solution resulting from the first-level optimization operations.

E. The system as paragraph D recites, wherein the solving module is configured to: based, at least in part, on the rate of convergence, transition from performing the first-level optimization operations to performing the second-level optimization operations

F. The system as paragraph A recites, wherein the first-level or the second-level optimization operations comprise simulated annealing.

7. The system as paragraph A recites, wherein performing the second-level optimization operations are based, at least in part, on results of the first-level optimization operations.

G. The system as paragraph A recites, wherein the memory module is configured to: store local optimum configurations of the set of variables for a plurality of first-level subsets and second-level subsets, and wherein the solving module is configured to: determine a best solution among the local optimum configurations for each of the first-level subsets and the second-level subsets.

H. The system as paragraph G recites, wherein the solving module is further configured to: apply the best solution among the local optimum configurations for the first-level subsets to performing the second-level optimization operations on the objective function.

I. The system as paragraph A recites, wherein the variables of the set of variables comprise discrete variables.

K. The system as paragraph A recites, wherein the variables comprise continuous variables, and wherein the solving module is further configured to: reinitialize the first-level and the second-level subsets by adding Gaussian noise.

L. A method comprising: receiving an objective function that associates a set of variables with one another; defining a first level that includes a first-order subset of the set of variables; defining a second level that includes a second-order subset of the first-order subset; performing an optimization operation on the objective function in the second level to generate a first result; reinitializing the second-order subset; performing the optimization operation on the objective function in the second level based, at least in part, on the first result and the reinitialized second-order subset to generate a second result; comparing the first result to the second result to determine an amount by which the second result is closer than the first result to a local optimum; if the amount is less than a threshold value, then reinitializing the second-order subset; and if the amount is greater than the threshold value, then performing the optimization operation on the objective function in the first level based, at least in part, on the second result and a reinitialized first-order subset; and determining a local optimum configuration for the objective function based, at least in part, on the optimization operation in the first-level.

M. The method as paragraph L recites, wherein the objective function includes a coupling term that defines coupling among the set of variables.

N. The method as paragraph L recites, wherein sizes of the first-order subset and the second-order subset are unchanged during the reinitializing of the first-order subset and the second-order subset, respectively.

O. The method as paragraph L recites, wherein the variables comprise continuous variables.

P. One or more computer-readable media storing computer-executable instructions that, when executed on one or more processors, configure a computer to perform acts comprising: partitioning a set of variables into a hierarchy of subsets on a first level and a second level of the hierarchy; performing optimization operations on an objective function that associates the set of variables with one another, wherein the optimization operations are performed using a reinitialized subset on a first level of the hierarchy; performing optimization operations on the objective function using a reinitialized subset on a second level of the hierarchy; and determining a local optimum configuration for the objective function based, at least in part, on the optimization operations.

Q. The computer-readable media as paragraph P recites, wherein the set of variables contains the subset on the second level and the subset on the second level contains the subset on the first level.

R. The computer-readable media as paragraph P recites, wherein the acts further comprise: randomly selecting sizes of the subsets on the first level and the second level.

S. The computer-readable media as paragraph P recites, wherein the acts further comprise: selecting sizes of the subsets on the first level and the second level based, at least in part, on coupling among the set of variables.

T. The computer-readable media as paragraph P recites, wherein the optimization operation comprises simulated annealing.

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “may” or “may,” unless specifically stated otherwise, are understood within the context to present that certain examples include, while other examples do not include, certain features, variables and/or steps. Thus, such conditional language is not generally intended to imply that certain features, variables and/or steps are in any way required for one or more examples or that one or more examples necessarily include logic for deciding, with or without user input or prompting, whether certain features, variables and/or steps are included or are to be performed in any particular example.

Conjunctive language such as the phrase “at least one of X, Y or Z,” unless specifically stated otherwise, is to be understood to present that an item, term, etc. may be either X, Y, or Z, or a combination thereof.

Any process descriptions, variables or blocks in the flow diagrams described herein and/or depicted in the attached figures should be understood as potentially representing modules, segments, or portions of code that include one or more executable instructions for implementing specific logical functions or variables in the routine. Alternate implementations are included within the scope of the examples described herein in which variables or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the variables of which are to be understood as being among other acceptable examples. All such modifications and variations are intended to be included herein within the scope of this disclosure and protected by the following claims.

What is claimed is:

1. A system comprising:
one or more processing units; and
computer-readable media with modules thereon, the modules comprising:
a memory module to store a set of variables and an objective function that associates the set of variables with one another;
a hierarchical structuring module to partition the set of variables into a first-level subset and a second-level subset, wherein the first-level subset is a subset of the second-level subset, and the second-level subset is a subset of the set of variables; and
a solving module to:
reinitialize the first-level subset prior to performing first-level optimization operations on the objective function that are based, at least in part, on the reinitialized first-level subset;
reinitialize the second-level subset prior to performing second-level optimization operations on the objective function that are based, at least in part, on the reinitialized second-level subset; and
determine a local optimum configuration for the objective function based, at least in part, on the second-level optimization operations.

2. The system of claim 1, wherein a size of the first-level subset is less than a size of the second-level subset.

3. The system of claim 1, wherein the solving module is configured to:
maintain values of the set of variables while reinitializing the first-level subset or while reinitializing the second-level subset.

4. The system of claim 1, wherein the solving module is configured to:
determine a rate of convergence toward a k-optimum solution resulting from the first-level optimization operations.

5. The system of claim 4, wherein the solving module is configured to:
based, at least in part, on the rate of convergence, transition from performing the first-level optimization operations to performing the second-level optimization operations.

6. The system of claim 1, wherein the first-level or the second-level optimization operations comprise simulated annealing.

7. The system of claim 1, wherein performing the second-level optimization operations are based, at least in part, on results of the first-level optimization operations.

8. The system of claim 1, wherein the memory module is configured to:
store local optimum configurations of the set of variables for a plurality of first-level subsets and second-level subsets, and wherein the solving module is configured to:
determine a best solution among the local optimum configurations for each of the first-level subsets and the second-level subsets.

9. The system of claim 8, wherein the solving module is further configured to:
apply the best solution among the local optimum configurations for the first-level subsets to performing the second-level optimization operations on the objective function.

10. The system of claim 1, wherein the variables of the set of variables comprise discrete variables.

11. The system of claim 1, wherein the variables comprise continuous variables, and wherein the solving module is further configured to:
reinitialize the first-level and the second-level subsets by adding Gaussian noise.

12. A method comprising:
receiving an objective function that associates a set of variables with one another;
defining a first level that includes a first-order subset of the set of variables;
defining a second level that includes a second-order subset of the first-order subset;
performing an optimization operation on the objective function in the second level to generate a first result;
reinitializing the second-order subset;
performing the optimization operation on the objective function in the second level based, at least in part, on the first result and the reinitialized second-order subset to generate a second result;
comparing the first result to the second result to determine an amount by which the second result is closer than the first result to a local optimum;
if the amount is less than a threshold value, then
reinitializing the second-order subset; and
if the amount is greater than the threshold value, then
performing the optimization operation on the objective function in the first level based, at least in part, on the second result and a reinitialized first-order subset; and
determining a local optimum configuration for the objective function based, at least in part, on the optimization operation in the first-level.

13. The method of claim 12, wherein the objective function includes a coupling term that defines coupling among the set of variables.

14. The method of claim 12, wherein sizes of the first-order subset and the second-order subset are unchanged during the reinitializing of the first-order subset and the second-order subset, respectively.

15. The method of claim 12, wherein the variables comprise continuous variables.

16. One or more computer-readable media storing computer-executable instructions that, when executed on one or more processors, configure a computer to perform acts comprising:
partitioning a set of variables into a hierarchy of subsets on a first level and a second level of the hierarchy;
performing optimization operations on an objective function that associates the set of variables with one another, wherein the optimization operations are performed using a reinitialized subset on a first level of the hierarchy;
performing optimization operations on the objective function using a reinitialized subset on a second level of the hierarchy; and
determining a local optimum configuration for the objective function based, at least in part, on the optimization operations.

17. The computer-readable media of claim 16, wherein the set of variables contains the subset on the second level and the subset on the second level contains the subset on the first level.

18. The computer-readable media of claim 16, wherein the acts further comprise:
randomly selecting sizes of the subsets on the first level and the second level.

19. The computer-readable media of claim 16, wherein the acts further comprise:
selecting sizes of the subsets on the first level and the second level based, at least in part, on coupling among the set of variables.

20. The computer-readable media of claim 16, wherein the optimization operation comprises simulated annealing.
